(19) United States
(12) Patent Application Publication
(10) Pub. No.: US 2021/0146953 A1
(43) Pub. Date: May 20, 2021

(54) Electronic Control Unit

(71) Applicant: Hitachi Automotive Systems, Ltd., Hitachinaka-shi, Ibaraki (JP)

(72) Inventors: Yuki HORITA, Tokyo (JP); Shigenori HAYASE, Hitachinaka-shi (JP); Makoto KUDO, Hitachinaka-shi (JP)

(21) Appl. No.: 17/263,482

(22) PCT Filed: May 31, 2019
(86) PCT No.: PCT/JP2019/021816

§ 371 Date: Jan. 26, 2021

(30) Foreign Application Priority Data
Jul. 27, 2018 (JP) 2018-141892

(51) Int. Cl. B60W 60/00; G06K 9/00; B60W 50/02; G01C 21/00; B60W 40/02

(52) U.S. Cl. CPC B60W 60/001; G06K 9/00791; B60W 50/0205; B60W 2520/10; B60W 40/02; B60W 2520/06; G01C 21/3815

(57) ABSTRACT

An electronic control unit includes a control unit that controls automatic traveling of a vehicle, an information generation unit that generates information necessary for the automatic traveling, an abnormality detection unit that detects an abnormality, and a function reconfiguration unit that lowers a functional level of the information generation unit and activates the control unit when the abnormality detection unit detects an abnormality.

### TECHNICAL FIELD

The present invention relates to an electronic control unit.

### BACKGROUND ART

In recent years, in order to achieve comfortable and safe automatic driving of a vehicle, a technique has been proposed that enables safe retreat control even if a part of a vehicle system fails. PTL 1 discloses a traveling control device of a vehicle that includes a traveling environment information acquisition means for acquiring traveling environment information of where an own vehicle is traveling, and a traveling information detection means for detecting traveling information of the own vehicle, and executes automatic driving control based on the traveling environment information and the traveling information of the own vehicle, the device including an own vehicle surrounding object detection means, which is different from the traveling environment information acquisition means, for detecting an object around the own vehicle, an environmental information acquisition and abnormality detection means for detecting an abnormality of the traveling environment information acquisition means, and a retreat control means for, when the abnormality of the above traveling environment information acquisition is detected, setting a traveling path for the own vehicle to retreat to a road side as a target traveling path based on the traveling environment information detected last time before the acquisition of the traveling environment information becomes abnormal and the traveling information, executing retreat control to cause the own vehicle to retreat to the roadside by automatic driving, and activating the own vehicle surrounding object detection means and, when an object around the own vehicle is detected by the own vehicle surrounding object detection means, executing the retreat control based on object information around the own vehicle, the traveling environment information detected last time before the acquisition of the traveling environment information becomes abnormal, and the traveling information.

### CITATION LIST

### Patent Literature

PTL 1: JP 2016-88180 A

### SUMMARY OF INVENTION

### Technical Problem

In the invention described in PTL 1, redundant execution of the traveling control device is required in order to enable control of the vehicle when the traveling control device fails.

### Solution to Problem

An electronic control unit according to a first aspect of the present invention includes a control unit that controls automatic traveling of a vehicle, an information generation unit that generates peripheral route map data that is information necessary for the automatic traveling, an abnormality detection unit that detects an abnormality, and a function reconfiguration unit that lowers a functional level of the information generation unit and activates the control unit when the abnormality detection unit detects an abnormality.

### Advantageous Effects of Invention

According to the present invention, a vehicle can be controlled even when a traveling control device fails without redundantly executing a traveling control device.

### BRIEF DESCRIPTION OF DRAWINGS

FIG. 1 is a configuration diagram at a normal time of a vehicle system 1 according to a first embodiment.

FIG. 2 is a configuration diagram of the vehicle system 1 when a traveling control device 4 according to the first embodiment fails.

FIG. 3 is a diagram illustrating a relationship between a road map data group 31 and a peripheral route map data group 33 according to the first embodiment.

FIG. 4 is a diagram illustrating an example of a traveling road environment and a scene when a failure occurs in the traveling control device 4 according to the first embodiment.

FIG. 5 is a process flow diagram of the vehicle system 1 before a failure of the traveling control device 4 according to the first embodiment.

FIG. 6 is a process flow diagram of function reconfiguration by a map management device 3 according to the first embodiment.

FIG. 7 is a process flow diagram of the vehicle system 1 at a time of failure of the traveling control device 4 according to the first embodiment.

FIG. 8 is a configuration diagram at a normal time of a vehicle system 1 according to a second embodiment.

FIG. 9 is a configuration diagram of the vehicle system 1 at a time of failure of a traveling control device 4 according to the second embodiment.

FIG. 10 is a process flow diagram of normal traveling of the vehicle system 1 before the failure of the traveling control device 4 according to the second embodiment.

FIG. 11 is a process flow diagram of the vehicle system 1 at the time of failure of the traveling control device 4 according to the second embodiment.

FIG. 12 is a configuration diagram at a normal time of a vehicle system 1 according to a third embodiment.

FIG. 13 is a configuration diagram of the vehicle system 1 at a time of failure of a traveling control device 4 according to the third embodiment.

### DESCRIPTION OF EMBODIMENTS

### First Embodiment

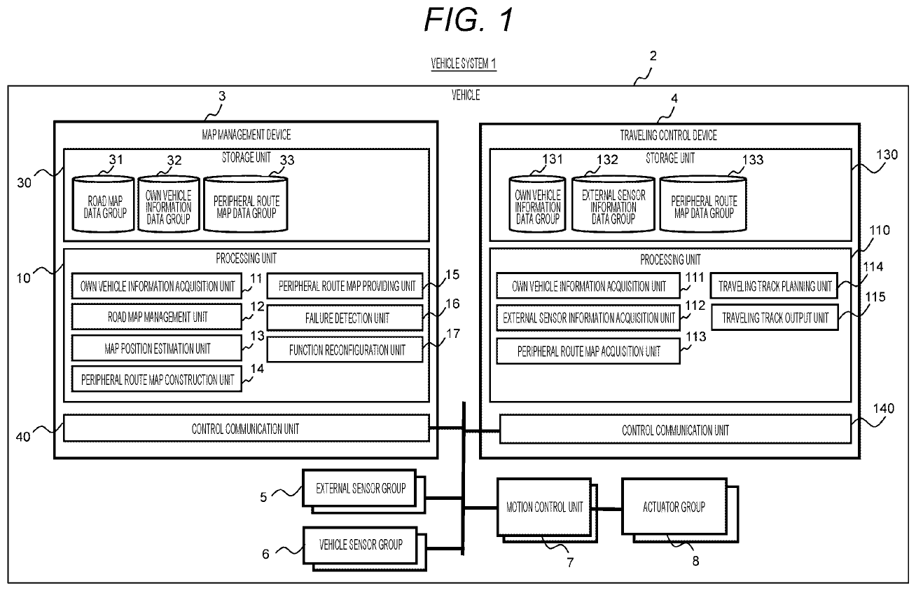

Hereinafter, a first embodiment of a map management device 3 which is an electronic control unit will be described with reference to FIGS. 1 to 7.

(Configuration at Normal Time)

FIG. 1 is a functional block diagram illustrating a configuration of a vehicle system 1 including a vehicle electronic control unit according to the first embodiment of the present invention. However, the configuration illustrated in FIG. 1 is at a normal time without any failure. The vehicle system 1 according to the present embodiment is a system that is mounted on a vehicle 2 and is for performing appropriate driving support or traveling control after recognizing a situation of a traveling road and obstacles such as surrounding vehicles around the vehicle 2. As illustrated in FIG. 1, the vehicle system 1 includes a map management device 3, a traveling control device 4, an external sensor group 5, a vehicle sensor group 6, a motion control unit 7, and an actuator group 8.

(System configuration map management device 3) The map management device 3 is an electronic control unit (ECU) that provides map-related information to devices mounted on the vehicle 2, such as the traveling control device 4, and includes a processing unit 10, a storage unit 30, and a communication control unit 40.

The processing unit 10 includes, for example, a central processing unit (CPU), a graphics processing unit (GPU), and a field-programmable gate array (FPGA). The processing unit has, as a part for achieving functions of the map management device 3, an own vehicle information acquisition unit 11, a road map management unit 12, a map position estimation unit 13, a peripheral route map construction unit 14, a peripheral route map providing unit 15, a failure detection unit 16, and a function reconfiguration unit 17. The processing unit 10 achieves these functions by executing a predetermined operating program stored in the storage unit 30. The processing unit 10 can also achieve a function different from that described above by executing, for example, a different operating program.

The own vehicle information acquisition unit 11 acquires, as the own vehicle information related to movement, state, plan, and the like of the vehicle 2, for example, information of a position, a traveling speed, a steering angle, an operating amount of an accelerator, an operating amount of a brake, a traveling route, and the like of the vehicle 2 from a built-in sensor that is not illustrated of the map management device 3, the vehicle sensor group 6, and the like. The own vehicle information acquired by the own vehicle information acquisition unit 11 is stored in the storage unit 30 as an own vehicle information data group 32. Note that in the following, the position of the vehicle 2 is referred to as “own vehicle position”, and information indicating the own vehicle position is also referred to as “own vehicle position information”. Note that the own vehicle position is, for example, a combination of latitude and longitude.

The road map management unit 12 manages a road map data group 31 which is road map data related to an entire area or partial area at a destination of the vehicle 2 on the storage unit 30. The road map data group 31 is, for example, road map data of the entire area at the destination of the vehicle 2, and is stored in a storage device corresponding part of the storage unit 30. The road map management unit 12 reads the road map data around the vehicle 2 from the road map data group 31 into a memory corresponding part of the storage unit 30 based on the position information of the vehicle 2 acquired by the own vehicle information acquisition unit 11. Thus, it becomes possible to access the road map data that needs to be processed, such as the map position estimation unit 13 and the peripheral route map construction unit 14. These road map data are stored in the storage unit 30 as the road map data group 31.

The map position estimation unit 13 estimates the road section and lane position in which the vehicle 2 is traveling based on the road map data group 31 around the own vehicle and the own vehicle information data group 32 which are stored in the storage unit 30. The road and position on lane in which the vehicle 2 is traveling, which are identified by the map position estimation unit 13, are written in a peripheral route map data group 33, which will be described later.

The peripheral route map construction unit 14 extracts the road map data along the traveling route of the vehicle 2 and constructs peripheral route map data in which the data is structured according to a predetermined method. In other words, the peripheral route map data includes the road map data around the vehicle 2. The peripheral route map data is stored in the storage unit 30 as the peripheral route map data group 33. As the traveling route of the vehicle 2, an already constructed traveling route may be acquired from another device such as a navigation device. Further, the traveling route of the vehicle 2 may be constructed in the peripheral route map construction unit 14 by acquiring destination information set by the driver via a human machine interface (HMI) device. Furthermore, the traveling route of the vehicle 2 may be treated as a virtual traveling route along the road without a specific destination.

The peripheral route map providing unit 15 transmits the peripheral route map data group 33 constructed by the peripheral route map construction unit 14 to the traveling control device 4 via the communication control unit 40. The failure detection unit 16 monitors and detects failures of devices and functions inside the map management device 3 and devices outside the map management device 3, such as the traveling control device 4. For example, the failure detection unit 16 can detect a failure of the traveling control device 4 by not receiving a message, which is normally transmitted from the traveling control device 4 periodically, for a certain period of time.

The function reconfiguration unit 17 reconfigures a function executed by the map management device 3 in a situation in which the vehicle system 1 is operating. Reconstruction of the function means, for example, reading a different program into a RAM when the CPU or GPU executes processing, and reconfiguring a logic circuit when the FPGA executes processing.

The storage unit 30 includes, for example, a storage device such as a hard disk drive (HDD), a flash memory, and a read only memory (ROM), and a memory such as a RAM. The storage unit 30 stores a program processed by the processing unit 10, a data group required for the process, and the like. Further, the storage unit 30 is also used in an application for temporarily storing data necessary for operation of the program as a main memory when the processing unit 10 executes a program. In the present embodiment, in particular, the road map data group 31, the own vehicle information data group 32, and the peripheral route map data group 33 are stored in the storage unit 30 as information for achieving the functions of the map management device 3.

The road map data group 31 is a set of road map data related to an entire area or partial area at the destination of the vehicle 2. For example, road map data related to the entire area at the destination is stored in a storage device such as an HDD, and road map data around the vehicle 2 based on the position information of the vehicle 2 is stored in the memory such as the RAM. The own vehicle information data group 32 is a set of data related to the movement, state, plan, and the like of the vehicle 2. For example, information of the position, the traveling speed, the steering angle, the operating amount of the accelerator, the operating amount of the brake, the traveling route, and the like of the vehicle 2 are included.

The peripheral route map data group 33 is a set of the peripheral route map data generated by the peripheral route map construction unit 14. The communication control unit 40 is configured to include, for example, a network card conforming to a communication standard such as IEEE802.3 or Controller Area Network (CAN, registered trademark), and the like, so as to transmit and receive data to and from other devices in the vehicle system 1 based on various protocols.

Note that in the present embodiment, the communication control unit 50 is described separately from the processing unit 10, but a part of processing of the communication control unit 50 may be executed in the processing unit 10. For example, it is possible to configure so that a hardware device equivalent in communication processing is located in the communication control unit 50, and other device drivers, communication protocol processing, and the like are located in the processing unit 10.

(System configuration traveling control device 4) The traveling control device 4 is an ECU that plans a traveling track of the vehicle 2 based on, for example, map-related information provided by the map management device 3, various sensor information and the like provided by the external sensor group 5, the vehicle sensor group 6, and the like, and outputs the traveling track to the motion control unit 7. The traveling control device 4 includes a processing unit 110, a storage unit 130, and a communication control unit 140.

The processing unit 110 includes, for example, a CPU, a GPU, an FPGA, and the like. The processing unit 110 has, as a part for achieving functions of the traveling control device 4, an own vehicle information acquisition unit 111, an external sensor information acquisition unit 112, a peripheral route map acquisition unit 113, a traveling track planning unit 114, and a traveling track output unit 115. The processing unit 110 achieves these functions by executing a predetermined operating program stored in the storage unit 130.

The own vehicle information acquisition unit 111 acquires, as the own vehicle information related to the movement, state, plan, and the like of the vehicle 2, for example, information of a position, a traveling speed, a steering angle, an operating amount of an accelerator, an operating amount of a brake, a traveling route, and the like of the vehicle 2 from the vehicle sensor group 6 and the like. The own vehicle information acquired by the own vehicle information acquisition unit 111 is stored in the storage unit 130 as an own vehicle information data group 131.

The external sensor information acquisition unit 112 acquires information regarding a traveling environment around the vehicle 2 detected by the external sensor group 5 from the external sensor group 5. Information regarding the traveling environment around the vehicle 2 includes other vehicles, obstacles such as pedestrians and falling objects, road environment such as white lines, roadsides, and road surface conditions, and traffic signs such as road signs and signals around vehicle 2. The information acquired by the external sensor information acquisition unit 112 is stored in the storage unit 130 as an external sensor information data group 132.

The peripheral route map acquisition unit 113 acquires the peripheral route map data output by the map management device 3. The acquired peripheral route map data is stored in the storage unit 130 as a peripheral route map data group 133.

The traveling track planning unit 114 plans a track that the vehicle 2 is going to travel (hereinafter referred to as “traveling track”) based on the own vehicle information data group 131, the external sensor information data group 132, the peripheral route map data group 133, and the like stored in the storage unit 130. The traveling track output unit 115 outputs information on the traveling track planned by the traveling track planning unit 114 (hereinafter referred to as “traveling track information”) to the motion control unit 7.

The storage unit 130 includes, for example, a storage device such as an HDD, a flash memory, and a ROM, and a memory such as a RAM. The storage unit 130 stores a program processed by the processing unit 110, a data group required for the processing, and the like. Further, it is also used in an application for temporarily storing data necessary for operation of the program as a main memory when the processing unit 110 executes a program. In the present embodiment, the own vehicle information data group 131, the external sensor information data group 132, and the peripheral route map data group 133 are stored in the storage unit 130 as information for achieving the functions of the traveling control device 4.

The own vehicle information data group 131 is a set of data related to the movement, state, plan, and the like of the vehicle 2. The own vehicle information data group 131 includes, for example, information of the position, the traveling speed, the steering angle, the operating amount of the accelerator, the operating amount of the brake, and the traveling route of the vehicle 2. The external sensor information data group 132 is an aggregate of data related to the traveling environment around the vehicle 2 detected by the external sensor group 5. The peripheral route map data group 133 is a set of data related to the peripheral route map information acquired from the map management device 3.

The communication control unit 40 is configured to include, for example, a network card conforming to a communication standard such as IEEE802.3 or CAN, so as to transmit and receive data to and from other devices in the vehicle system 1 based on various protocols.

The external sensor group 5 is an aggregate of devices for detecting the state around the vehicle 2, and corresponds to, for example, a camera device, a millimeter wave radar, a laser radar, a sonar, and the like. Each external sensor detects environmental elements such as obstacles, road environments, and traffic signs existing in a predetermined range from the vehicle 2 and outputs them to an in-vehicle network. Obstacles are, for example, obstacles that impede other vehicles, pedestrians, and passage of vehicles.

The vehicle sensor group 6 is an aggregate of devices for detecting the state of the vehicle 2. Each vehicle sensor detects, for example, the position information of the vehicle 2, the traveling speed, the steering angle, the operating amount of the accelerator, the operating amount of the brake, and the like, and outputs them to the in-vehicle network. The motion control unit 7 controls the actuator group 8 so that the vehicle 2 travels on the same track based on the traveling track information output from the traveling control device 4.

The actuator group 8 is a group of devices controlling control elements such as a steering, a brake, and an accelerator that determine movement of the vehicle. The actuator group 8 controls movement of the vehicle based on operation information of a steering wheel, a brake pedal, an accelerator pedal, and the like by the driver and control information output from the traveling control device 4.

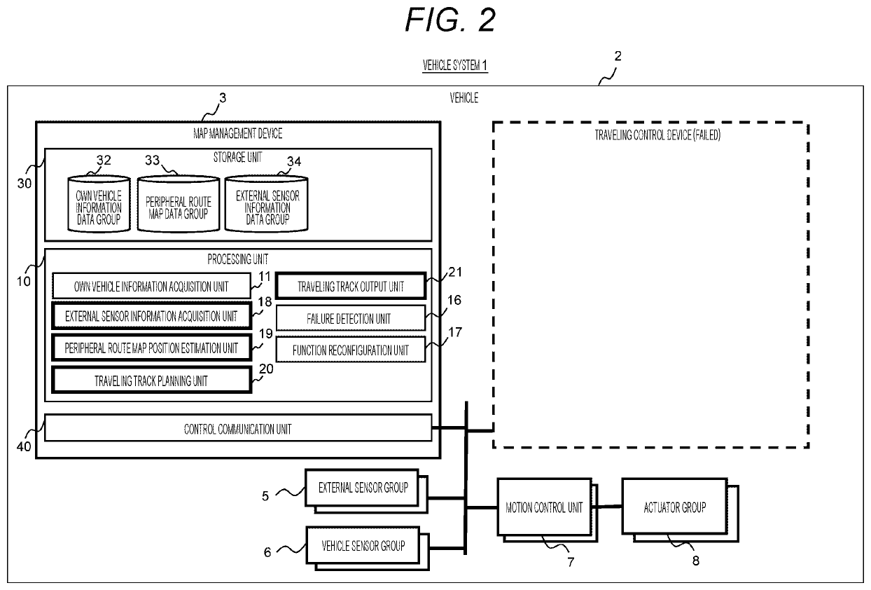

(Configuration at time of failure) FIG. 2 is a functional block diagram illustrating a configuration of the vehicle system 1 after the function reconfiguration due to occurrence of a failure of the traveling control device 4. In the present embodiment, when the traveling control device 4 fails, the failure detection unit 16 of the map management device 3 detects the failure of the traveling control device 4. Then, the function reconfiguration unit 17 of the map management device 3 dynamically reconfigures the processing unit 10 of the map management device 3 and rewrites a part of the storage unit 30. Thus, the map management device 3 replaces the function of the failed traveling control device 4.

The reconfiguration here means terminating a part of the functions that have been operating until then, releasing the hardware resources (CPU, memory, and the like) used by the terminated functions, and starting another function instead. Note that there are various hardware resources to be released, and for example, in a case where only the CPU is released, a program to be started is placed in the memory in advance and arithmetic processing is switched. Further, in a case where not only the CPU but also the memory is released, the program loaded in the memory is deleted and the arithmetic processing is switched.

An alternative function of the traveling control device 4 is to output a traveling track for safely continuing automatic traveling of the vehicle 2 to the motion control unit 7. The traveling track for safely continuing automatic traveling may be a traveling track that achieve automatic traveling equivalent to that of the traveling control device 4, or may be a traveling track for safely stopping on a nearby road shoulder, and is determined based on safety concept of the vehicle system 1. FIG. 2 targets at an alternative function for safely stopping on a nearby road shoulder on a dedicated road.

The road map management unit 12, the map position estimation unit 13, the peripheral route map construction unit 14, and the peripheral route map providing unit 15 that have been operating before the failure of the traveling control device 4, that is, at the normal time illustrated in FIG. 1, have functions of generating peripheral route map data and providing the peripheral route map data to the traveling control device 4. However, for the purpose of constructing the traveling track for safely stopping on the nearby road shoulder, they are not essential functions for the vehicle system 1 after the traveling control device 4 fails because it is possible to be handled within the range of the peripheral route map data generated last time. Therefore, the function reconfiguration unit 17 of the map management device 3 terminates these non-essential functions, and instead activates an external sensor information acquisition unit 18, a peripheral route map position estimation unit 19, a traveling track planning unit 20, and a traveling track output unit 21. At that time, the memory for storing the road map data group 31 of the storage unit 30 used by the road map management unit 12 is released, and an external sensor information data group 34 is stored instead.

That is, although not described in FIG. 1, the external sensor information acquisition unit 18, the peripheral route map position estimation unit 19, the traveling track planning unit 20, and the traveling track output unit 21 are included in the map management device 3 in a stopped state. By the function reconfiguration unit 17 performing reconfiguration, the external sensor information acquisition unit 18, the peripheral route map position estimation unit 19, the traveling track planning unit 20, and the traveling track output unit 21 become operable. In the following, the traveling track planning unit 20 and the traveling track output unit 21 may also be referred to as a “control unit”.

The external sensor information acquisition unit 18 corresponds to the external sensor information acquisition unit 112 of the traveling control device 4, and acquires the information regarding the traveling environment around the vehicle 2 detected by the external sensor group 5 from the external sensor group 5. The external sensor information acquisition unit 18 may acquire information equivalent to that of the traveling control device 4, or may acquire information limited to minimum information necessary for safely stopping on the nearby road shoulder. The information acquired by the external sensor information acquisition unit 18 is stored in the storage unit 30 as the external sensor information data group 34.

The peripheral route map position estimation unit 19 estimates the road section and lane position in which the vehicle 2 is traveling on the last peripheral route map data group 33 generated by the peripheral route map construction unit 14 before the failure occurs. A difference between the peripheral route map position estimation unit 19 and the map position estimation unit 13 is that target data for estimating the position of the vehicle 2 is not the road map data group 31 but the peripheral route map data group 33.

The traveling track planning unit 20 corresponds to the traveling track planning unit 114 of the traveling control device 4. The traveling track planning unit 20 plans the traveling track for safely stopping on the nearby road shoulder based on the own vehicle information data group 32, the peripheral route map data group 33, the external sensor information data group 34, and the like stored in the storage unit 30. The traveling track output unit 21 corresponds to the traveling track output unit 115 of the traveling control device 4, and outputs the traveling track information planned by the traveling track planning unit 20 to the motion control unit 7.

The motion control unit 7 controls the actuator group 8 based on the traveling track information output from the traveling control device 4 as described above before the failure of the traveling control device 4 occurs. After occurrence of the failure of the traveling control device 4, the motion control unit 7 controls the actuator group 8 based on the traveling track information output from the map management device 3. Note that, in a strict sense, it is a state that the traveling track information is not output from the time when the failure of the traveling control device 4 occurs until the alternative function of the map management device 3 outputs the traveling track. However, the motion control unit 7 can maintain the automatic traveling for a certain period of time by operating based on the traveling track information output last time by the traveling control device 4.

(Relationship Between Road Map Data Group 31 and Peripheral Route Map Data Group 33)

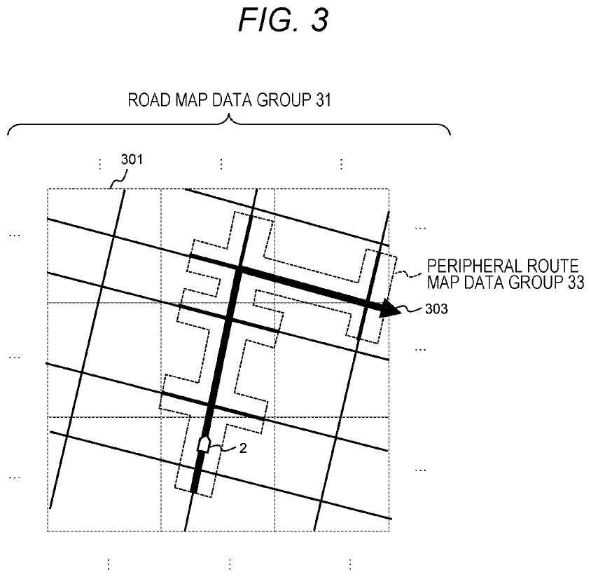

FIG. 3 is a diagram illustrating a relationship between the road map data group 31 and the peripheral route map data group 33 stored in the storage unit 30 of the map management device 3.

Each road map data constituting the road map data group is managed by being divided into regions (hereinafter referred to as “parcels”), which are divided into meshes in predetermined distance units in the latitude and longitude directions. The road map data group 31 is road map data related to the entire area of the destination of the vehicle 2. By the road map management unit 12, the position information of the vehicle 2 and the road map data of the parcels in which traveling route information indicated by reference numeral 303 in FIG. 3 is located and parcels around the parcel, that is, a part of the road map data group 31 are read into the memory.

The peripheral route map data group 33 is structured by extracting information necessary for planning a traveling track in the vehicle system 1 along the traveling route of the vehicle 2 from the road map data around the vehicle 2 read into the memory. For example, in FIG. 3, information related to the road in an area surrounded by a broken line is the peripheral route map data group 33. The peripheral route map data group 33 includes road shapes, road attributes, and the like related to a road section and a branch road within a predetermined distance range along the traveling route of the vehicle 2. The road shapes are, for example, roadsides, white lines, lane shapes, stop lines, and zebra zones, and the like. The road attributes are, for example, speed limits, traveling directions, and the like.

The parcel contains data related to all the roads in the area, and thus a large memory capacity is required to read the road map data in the range described above into the memory. However, what is required in the planning of the traveling track is the road map data around the road area in which the vehicle 2 is going to travel, and is only a small part of the road map data included in the parcel. Thus, by generating the peripheral route map data by extracting and structuring necessary information along the traveling route, and transmitting the peripheral route map data to the traveling control device 4, unnecessary data communication on the in-vehicle network and memory consumption in the traveling control device 4 can be suppressed.

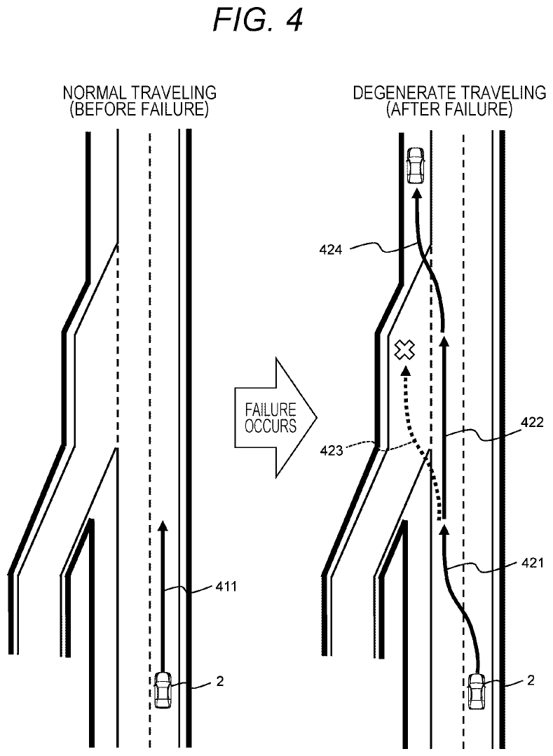

(Scene example) FIG. 4 is an example of a traveling road environment and a scene when the traveling control device 4 fails. A left side of FIG. 4 illustrates a state of automatic traveling of the vehicle 2 before the traveling control device 4 fails, and a right side of FIG. 4 illustrates a state of automatic traveling of the vehicle 2 after the traveling control device 4 fails, that is, a state of degenerate traveling. The degenerate traveling here is an automatic traveling for retreating to a nearby road shoulder and stopping there.

In the left diagram of FIG. 4, the vehicle 2 is traveling in an overtaking lane near the central reservation, and the traveling track 411 is planned so as to maintain the current traveling lane. If the traveling control device 4 fails in this state, in order to retreat to the nearby road shoulder, it is necessary to change the lane to the left lane (traveling track 421) and then pulls over and stops at the road shoulder (traveling track 424), as depicted with a solid line in the right diagram of FIG. 4. At this time, the map management device 3 needs to determine a safe stop destination after understanding the structure of the road.

For example, in the traveling road environment illustrated in FIG. 4, if it changes the lane to the left lane and then immediately pulls over and stops at the road shoulder, there is a risk that the vehicle enters a merging lane like a traveling track 423, and collides with another vehicle or obstructing merging to a main line of another vehicle. Therefore, a traveling track plan is needed to grasp that there is a merging point nearby in advance, and to pull over and stop at the road shoulder after passing the merging point. It is difficult to recognize existence of the merging point sufficiently in advance using outputs of the external sensor group 5, and it is preferable that information thereof is grasped using the road map data, specifically, the peripheral route map data.

Accordingly, the map management device 3 retains the peripheral route map data generated by the peripheral route map construction unit 14 as the peripheral route map data group 33 in the memory. Thus, the traveling track planning unit 20, which has been reconfigured at a time of failure of the traveling control device 4, can immediately refer to the road map data in the vicinity, and thus can generate a traveling track that pulls over and stops at the road shoulder by avoiding the merging point.

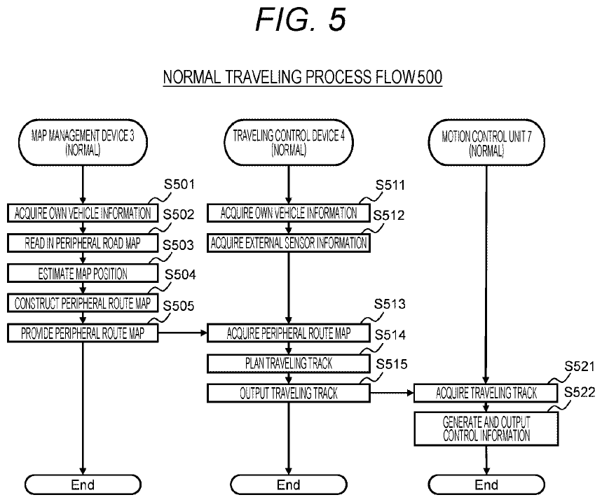

(Flowchart) A process flow of the map management device 3, the traveling control device 4, and the motion control unit 7 before and after a failure of the traveling control device 4 will be described with reference to FIGS. 5 to 7.

FIG. 5 is an explanatory diagram of a process flow of the vehicle system 1 before the failure of the traveling control device 4. In the present embodiment, the process flow illustrated in FIG. 5 is referred to as a normal traveling process flow 500 for convenience. The map management device 3 normally executes processes of S501 to S505 periodically.

First, in S501, the own vehicle information acquisition unit 11 acquires the own vehicle information related to the movement, state, plan, and the like of the vehicle 2. Subsequently, in S502, the road map management unit 12 reads the road map around the vehicle 2 from the road map data group 31 into the memory based on the own vehicle position information included in the own vehicle information acquired in S501. Note that at this time, road map data that is already stored in the memory and is information of an area whose distance have become far due to proceeding of the vehicle 2 may be deleted from the memory.

Next, in S503, the map position estimation unit 13 estimates the road section and the position on lane in which the vehicle 2 is traveling based on the road map data read into the memory, the traveling direction and speed of the vehicle 2 and a previous calculation result, and the like included in the own vehicle information acquired in S501. In S504, the peripheral route map construction unit 14 extracts the road map data along the traveling route of the vehicle 2, and constructs the peripheral route map data in which the data is structured according to a predetermined method.

The traveling route of the vehicle 2 is acquired from another device such as a navigation device and stored in the own vehicle information data group 32. Further, the constructed peripheral route map data is also stored in the memory of the map management device 3 as the peripheral route map data group 33. Then finally, in S505, the peripheral route map providing unit 15 outputs the peripheral route map data constructed in S504 to the in-vehicle network. This peripheral route map data is used in S513 of the traveling control device 4 described below.

The traveling control device 4 periodically executes the processes illustrated in S511 to S515. First, in S511, the own vehicle information acquisition unit 111 acquires the own vehicle information related to the movement, state, plan, and the like of the vehicle 2. Subsequently, in the S512, the external sensor information acquisition unit 112 acquires detection information regarding the traveling environment around the vehicle 2 periodically output from the external sensor group 5, and stores the detection information in the external sensor information data group 132. In S513, the peripheral route map acquisition unit 113 acquires the peripheral route map data output from the map management device 3 and stores the peripheral route map data in the peripheral route map data group 133.

In S514, the traveling track planning unit 114 constructs a traveling track during normal traveling based on the own vehicle information data group 131, the external sensor information data group 132, the peripheral route map data group 133, and the like stored in the storage unit 130. Then finally, in S515, the traveling track output unit 115 outputs the constructed traveling track to the motion control unit 7.

When the traveling control device 4 outputs the traveling track by the process of S515 described above, the motion control unit 7 executes S521 and S522 described below. The motion control unit 7 acquires traveling track information periodically output by the traveling control device 4 (S521), generates a control command value for each actuator of the actuator group 8, and outputs the control command value to the actuator (S522). Thus, the motion control unit 7 controls the traveling of the vehicle 2.

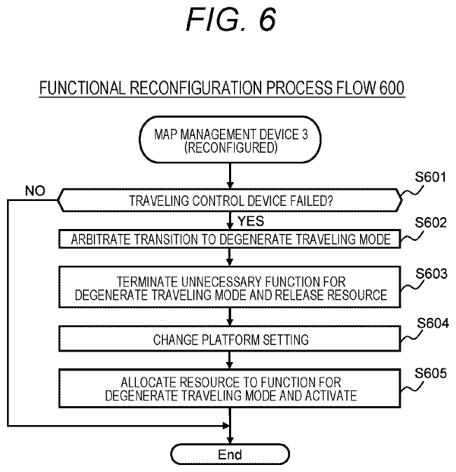

FIG. 6 is a diagram illustrating a process flow of function reconfiguration by the map management device 3. In the present embodiment, the process flow illustrated in FIG. 6 is referred to as a function reconfiguration process flow 600 for convenience.

The failure detection unit 16 of the map management device 3 periodically monitors the traveling control device 4 and monitors whether or not the traveling control device 4 is failed (S601). For example, if a message transmitted periodically from the traveling control device 4 is not received for a certain period of time, it is determined that the traveling control device 4 is failed. The map management device 3 terminates without performing anything if it is determined that the traveling control device 4 is operating normally (S601: NO). If it is determined that the traveling control device 4 is failed, the map management device 3 proceeds to S602 (S601: YES).

In S602, the function reconfiguration unit 17 arbitrates with other devices for transition to the degenerate traveling mode due to the failure of the traveling control device 4. In the present embodiment, the arbitration with other devices is not necessary because the function is reconfigured only by the map management device 3, but in general, it is necessary to transit to a specific mode while a plurality of devices keeping pace. If a mode mismatch occurs among the devices, the system no longer operates, and thus it is necessary to arbitrate among the related devices. As a method of arbitration, a predetermined device may determine the mode transition as a master, or each device may share its own determination result and make an autonomous determination.

Subsequently, in S603, the function reconfiguration unit 17 terminates part or all of the functions that are unnecessary in the degenerate traveling mode, and releases the hardware resources such as the CPU and the RAM used by the terminated functions. In the present embodiment, the road map management unit 12, the map position estimation unit 13, the peripheral route map construction unit 14, and the peripheral route map providing unit 15 correspond to the terminated functions.

In S604, the map management device 3 changes platform settings. For example, due to changes in the functions mounted in the map management device 3, it is necessary to transmit and receive data different from before to and from the outside, and there may be cases where it is necessary to change the settings on the platform side to allow this. Specifically, there are settings of changing a destination to which the external sensor group 5 and the vehicle sensor group 6 output information to the map management device 3, and stopping transmission to the map management device 3 because the information is unnecessary in the degenerate traveling mode. Necessary setting changes for functions to be activated in the next step to operate are executed here.

Then, in S605, the function reconfiguration unit 17 allocates hardware resources to functions necessary for the degenerate traveling mode, and activates the respective functions. In the present embodiment, the external sensor information acquisition unit 18, the peripheral route map position estimation unit 19, the traveling track planning unit 20, and the traveling track output unit 21 are activated. As above, functions necessary for the degenerate traveling illustrated in FIG. 4 are reconfigured by the map management device 3.

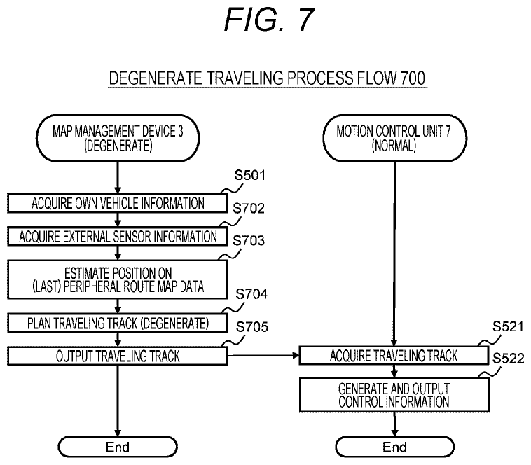

FIG. 7 is a diagram illustrating a process flow of the vehicle system 1 after the failure of the traveling control device 4. In the present embodiment, the process flow illustrated in FIG. 7 is referred to as a degenerate traveling process flow 700 for convenience. However, the operation of the motion control unit 7 is similar to that of the normal traveling process flow 500, and thus the description thereof will be omitted.

In S501, the own vehicle information acquisition unit 11 acquires the own vehicle information related to movement, state, plan, and the like of the vehicle 2 similarly to before the failure. In S702, the external sensor information acquisition unit 18 acquires detection information regarding the traveling environment around the vehicle 2 periodically output by the external sensor group 5, and stores the information in the external sensor information data group 34.

In S703, the peripheral route map position estimation unit 19 identifies the road and the position on lane in which the vehicle 2 is traveling in the peripheral route map data group 33 constructed last time by the peripheral route map construction unit 14 before the failure based on the own vehicle position information included in the own vehicle information acquired in S501. Note that as described above, the peripheral route map data group 33 includes the road and the position on lane identified by the map position estimation unit 13 before the failure.

In general, it is difficult to accurately identify the road and lane position only from the own vehicle position information because the internal state is lost immediately after the function is reconfigured. However, in the present embodiment, the road and the position on lane specified by the map position estimation unit 13 are included in the peripheral route map data group 33. Therefore, the operation can be started from the state where the past estimated value is retained, and using this as a clue, the road and lane position can be specified at high speed and accurately.

In S704, the traveling track planning unit 20 generates a traveling track to retreat to a nearby road shoulder based on the estimation result of S703, the peripheral route map data group 33, and the external sensor information data group 34. It is possible to grasp the road environment around the vehicle 2 from the position estimation result of the vehicle 2 with respect to the peripheral route map data group 33.

For example, under the situation illustrated in FIG. 4, it can be grasped that the vehicle 2 is traveling on the right lane of the two lanes and that there is a merge from a side road immediately in front of the vehicle 2, and the like. Further, white lines, other vehicles, and roadsides can be recognized by using the information output by the external sensor information data group 34. Thus, as in the example of the scene of FIG. 4, traveling control as follows is possible when retreating to a nearby road shoulder. That is, after changing lanes while observing the situation of other vehicles on the left lane (traveling track 421 in FIG. 4), it is possible to follow the lane until passing the merging area (traveling track 422 in FIG. 4), and then to pull over and stop while recognizing the roadside (traveling track 424 in FIG. 4).

In this manner, the traveling track planning unit 20 is achieved by, for example, a combination of lane change (Lane Change Assistance), lane following (Lane Keep Assistance/Adaptive Cruise Control), and retreat to road shoulder. Then finally, in S705, the traveling track output unit 21 outputs the traveling track generated in S704 to the motion control unit 7.

According to the first embodiment described above, the following effects can be obtained.

(1) The map management device 3 includes the traveling track planning unit 20 and the traveling track output unit 21 that control automatic traveling of the vehicle 2, the peripheral route map construction unit 14 that is an information generation unit that generates peripheral route map data that is information necessary for the automatic traveling, the failure detection unit 16 that detects an abnormality of the traveling control device 4, and the function reconfiguration unit 17 that lowers a functional level of the peripheral route map construction unit 14, and activates the traveling track planning unit 20 and the traveling track output unit 21 when the failure detection unit 16 detects an abnormality. Thus, the vehicle 2 can be controlled even when the traveling control device 4 fails without redundant execution. Specifically, it is possible to improve safety of the vehicle system 1 at a lower cost as compared with the case of redundant execution.

(2) The function reconfiguration unit 17 lowers the functional level of the peripheral route map construction unit 14 by stopping at least a part of the peripheral route map construction unit 14. Therefore, resources can be secured by stopping functions that are not essential for traveling of the vehicle 2, and the resources can be allocated to the traveling track planning unit 20 and the traveling track output unit 21 that control the vehicle 2.

(3) If the failure detection unit 16 does not detect an abnormality, the traveling track planning unit 20 and the traveling track output unit 21 are in a stopped state. Thus, at a normal time, it is not necessary to allocate resources to the traveling track planning unit 20 and the traveling track output unit 21, and the resources can be allocated to other processes.

(4) The abnormality detected by the failure detection unit 16 is an abnormality of the traveling control device 4 that controls the automatic traveling of the vehicle 2 based on the peripheral route map data.

(5) The map management device 3 includes the storage unit 30 that stores the generated peripheral route map data group 33. The traveling track planning unit 20 and the traveling track output unit 21 control the automatic traveling of the vehicle 2 based on the peripheral route map data generated last time.

(6) The peripheral route map data is static information of the road environment around the vehicle 2. As a function unnecessary for the degenerate traveling after a failure of the traveling control device 4, a function of extracting and structuring road map data around the vehicle 2 or along the route is targeted. This takes advantage of the fact that because the degenerate traveling for retreating to the nearby road shoulder is not to travel a long distance, the range of the generated peripheral route map data is sufficient for responding. Further, because the data related to the road map is static information that does not change with the passage of time, the range required for the degenerate traveling is retained in advance, and thus processing related to generation of this data is unnecessary.

(Modification example 1) In the first embodiment described above, when the failure detection unit 16 detects an abnormality in the traveling control device 4, four of the road map management unit 12, the map position estimation unit 13, the peripheral route map construction unit 14, and the peripheral route map providing unit 15 are stopped. However, only a part of these four may be stopped. Further, a functional level may be lowered instead of stopping. Lowering the functional level means, for example, reducing the processing times of the CPU allocated to these four functional blocks and reducing the amounts of memory allocated to these four functional blocks. According to this modification example, it is possible to continue the generation of peripheral route map data while reducing the function.

(Modification example 2) In the first embodiment described above, retreat to a nearby road shoulder has been described as an example of degenerate traveling. However, in the degenerate traveling, it may be compared to other than the nearby road shoulder. In this case, the road map data group 31 that the map management device 3 has can be used. As described above, a device that handles map-related matters is suitable as a candidate for a reconfiguration destination of the functions necessary for the degenerate traveling at the time of failure of the traveling control device 4. The navigation device is also suitable as a candidate for the reconfiguration destination for a similar reason.

### Second Embodiment

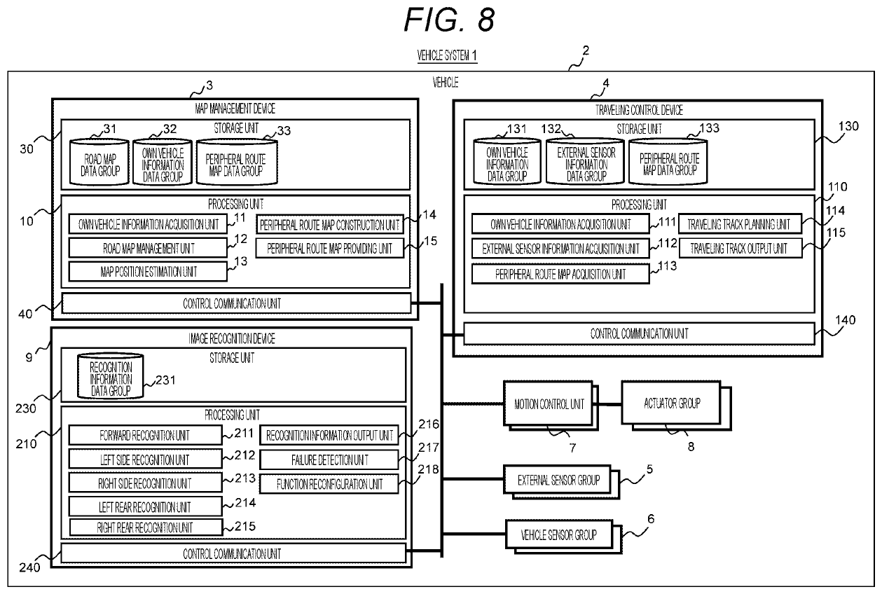

A second embodiment of an image recognition device, which is an electronic control unit, will be described with reference to FIGS. 8 to 11. In the following description, the same components as those in the first embodiment are designated by the same reference numerals, and differences will be mainly described. Points not particularly described are the same as those in the first embodiment. In the present embodiment, the device for reconfiguration at a time of failure is different from that in the first embodiment.

(Configuration at normal time) FIG. 8 is a functional block diagram illustrating a configuration of a vehicle system 1 according to the second embodiment. In the first embodiment, the map management device 3 is reconfigured so as to have functions for achieving the degenerate traveling at a time of failure of the traveling control device 4, but in the second embodiment, an image recognition device 9 that is one of the external sensor groups 5 is responsible for the functions.

The vehicle system 1 according to the present embodiment includes a map management device 3, a traveling control device 4, an external sensor group 5, a vehicle sensor group 6, a motion control unit 7, an actuator group 8, and an image recognition device 9. Besides the image recognition device 9, the configuration is similar to that of each device of the first embodiment except for the following points. That is, in the second embodiment, the map management device 3 does not include the failure detection unit 16 and the function reconfiguration unit 17.

The image recognition device 9 is, for example, a device that recognizes environmental elements, such as other vehicles, white lines, and roadsides, existing around the vehicle 2 from imaging data acquired from one or more cameras installed in the vehicle 2. The image recognition device 9 includes a processing unit 210, a storage unit 230, and a communication unit 240. The processing unit 210 has a forward recognition unit 211, a left side recognition unit 212, a right side recognition unit 213, a left rear recognition unit 214, a right rear recognition unit 215, a recognition information output unit 216, a failure detection unit 217, and a function reconfiguration unit 218 as functions for implementing functions of the image recognition device 9.

Each of the recognition units 211 to 215 is a function of recognizing environmental elements in the corresponding direction based on imaging data acquired from the above-mentioned camera. Note that it is not necessary for each direction to have a one-to-one correspondence with the imaging data, and for example, the left rear recognition unit 214 and the right rear recognition unit 215 may perform processing using imaging data of the same camera that captures the rear of the vehicle 2. Further, the forward recognition unit 211 may acquire imaging data from a plurality of cameras that images forward and process them in combination.

The recognition information output unit 216 integrates information recognized by the respective recognition units 211 to 215, stores the information as a recognition information data group 231 in the storage unit 230, and outputs the information to the in-vehicle network. The traveling control device 4 acquires the recognition information data group 231 as a part of the external sensor information data and stores it in the external sensor information data group 132. Functions of the failure detection unit 217 and the function reconfiguration unit 218 are equivalent to the functions of the failure detection unit 16 and the function reconfiguration unit 17 of the map management device 3 in the first embodiment, respectively.

The storage unit 230 stores a program processed by the processing unit 210, a data group required for the process, and the like. Further, it is also used in an application for temporarily storing data necessary for operation of the program as a main memory when the processing unit 210 executes a program. In the present embodiment, in particular, the recognition information data group 231 and the like are stored in the storage unit 230 as information for implementing the functions of the image recognition device 9. The recognition information data group 231 is a set of data related to environmental elements around the vehicle 2 recognized by the respective recognition units 211 to 215.

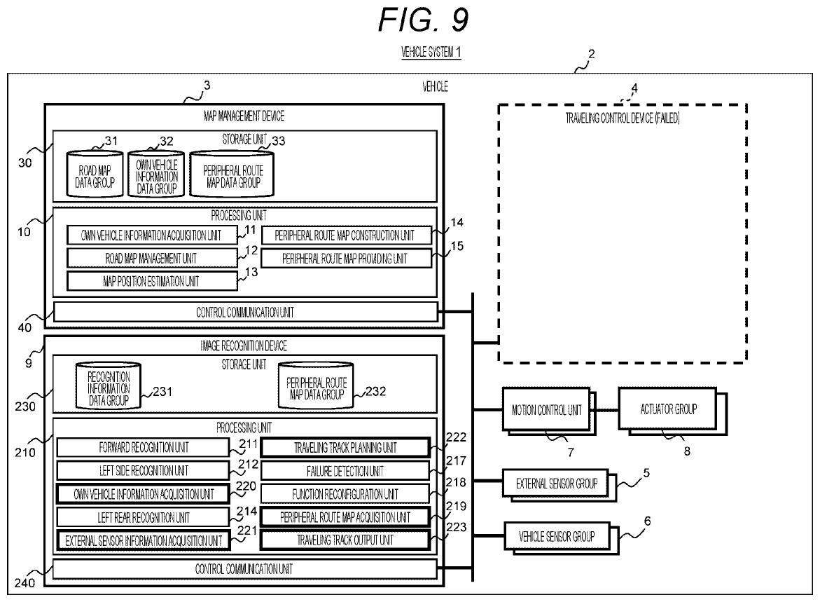

(Configuration at time of failure) FIG. 9 is a functional block diagram illustrating a configuration of the vehicle system 1 after the function reconfiguration due to occurrence of a failure of the traveling control device 4 in the second embodiment. In the present embodiment, the failure detection unit 217 of the image recognition device 9 detects that the traveling control device 4 has failed. Then, the function reconfiguration unit 218 dynamically reconfigures a part of the processing unit and the storage unit of the map management device 3 to activate, that is, enable a degenerate traveling function which is an alternative function of the failed traveling control device 4. The degenerate traveling function here is an automatic traveling function for retreating to a nearby road shoulder on a dedicated road, as in the first embodiment.

In order to retreat to the nearby road shoulder, as illustrated in FIG. 4, control is necessary for lane changing in the road shoulder direction, lane following, and pulling over and stopping at the road shoulder. For this purpose, it is necessary to recognize movement of other vehicles in the forward, left side, and left rear, and traveling environments such as a roadside. On the other hand, because of not moving to the lane on the center line side on the right side of the diagram, it is not necessary to recognize traveling environments on the right side and the rear right side.

Accordingly, the image recognition device 9 terminates the right side recognition unit 213 and the right rear recognition unit 215, which have been operating before the failure of the traveling control device 4, as unnecessary functions, and instead activates the peripheral route map acquisition unit 219, the own vehicle information acquisition unit 220, the external sensor information acquisition unit 221, the traveling track planning unit 222, and the traveling track output unit 223 as necessary functions for the degenerate traveling. The peripheral route map acquisition unit 219 is equivalent to the peripheral route map acquisition unit 113 of the traveling control device illustrated in FIG. 8. Further, the own vehicle information acquisition unit 220, the external sensor information acquisition unit 221, the traveling track planning unit 222, and the traveling track output unit 223 are equivalent to the own vehicle information acquisition unit 11, the external sensor information acquisition unit 18, the traveling track planning unit 20, and the traveling track output unit 21 of the map management device 3 of FIG. 2 in the first embodiment.

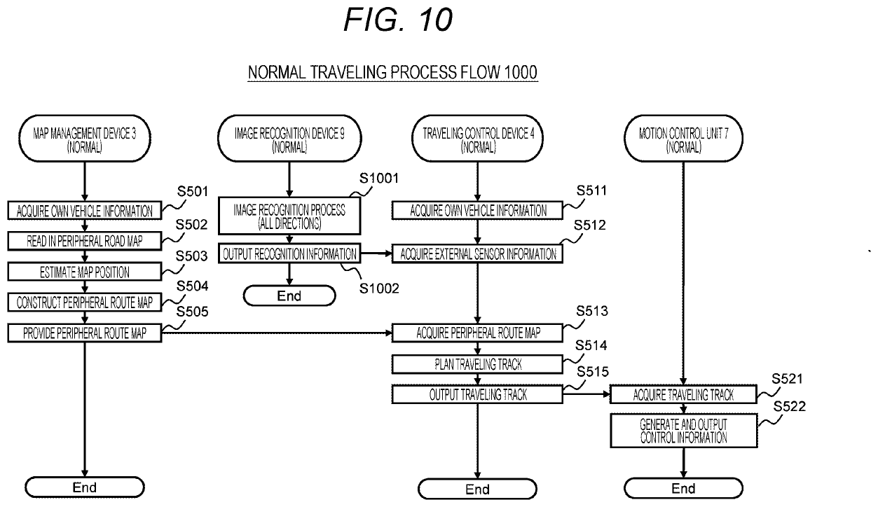

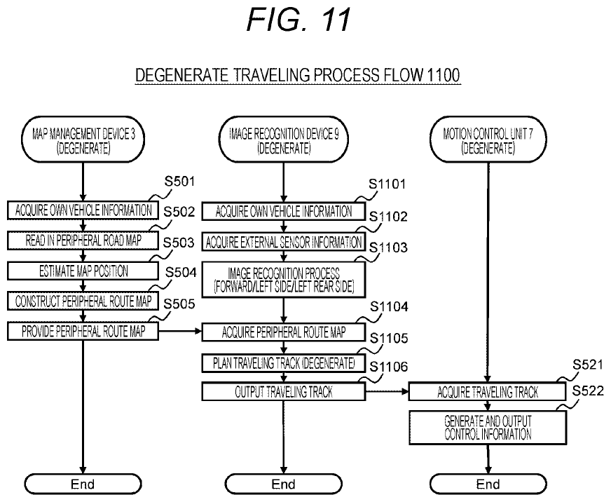

(Flowchart) With reference to FIGS. 10 and 11, processes of the map management device 3, the image recognition device 9, the traveling control device 4, and the motion control unit 7 before and after the traveling control device 4 fails in the present embodiment will be described.

FIG. 10 is a diagram illustrating a process flow of normal traveling of the vehicle system 1 before the failure of the traveling control device 4 in the present embodiment. In the present embodiment, the process flow illustrated in FIG. 10 is referred to as a normal traveling process flow 1000 for convenience. Because operations of the map management device 3, the traveling control device 4, and the motion control unit 7 are the same as those of FIG. 5 in the first embodiment, the description thereof will be omitted, and only a process flow of the image recognition device 9 will be described here.

The image recognition device 9 periodically executes processes of S1001 and S1002. In S1001, the respective recognition units 211 to 215 recognize environmental elements in respective directions based on imaging data acquired from the cameras mounted on the vehicle 2. Then, in S1002, the recognition information output unit 216 structures information of the environmental element recognized in S1001 according to a predetermined format and outputs the information to the in-vehicle network. The information is acquired by the external sensor information acquisition unit 112 of the traveling control device 4, and is stored as a part of the external sensor information data group 132 (S512).

FIG. 11 is a diagram illustrating a process flow of the vehicle system 1 after the traveling control device 4 fails. In the present embodiment, the process flow illustrated in FIG. 10 is referred to as a degenerate traveling process flow 1100 for convenience. Because the operations of the map management device 3 and the motion control unit 7 are similar to those of the normal traveling process flow 1000 before the failure of the traveling control device 4, the description thereof will be omitted.

In the image recognition device 9, S1101 to S1106 are periodically executed instead of S1001 and S1002 that have been executed before the failure. Each of S1101, S1102, S1105, and S1106 is equivalent to each of S501, S702, S704, and S705 of the degenerate traveling process flow 700 of the first embodiment. Further, S1104 is equivalent to S513 of the normal traveling process flow 1000 of the second embodiment.

In S1103, before the failure, the respective recognition units 211 to 215 all have been operated to recognize the environmental elements in all directions of the vehicle 2, but in the degenerate traveling mode after the failure, only the forward, left side, and left rear recognition units (211, 212, 214) are operated. By the above process flow, the image recognition device 9 starts to output the traveling track of the degenerate traveling to the motion control unit 7 instead of the traveling control device 4, and the automatic traveling can be continued. Note that the process flow in which the image recognition device 9 reconfigures the functions is equivalent to that in FIG. 6.

According to the second embodiment described above, the following operation and effect can be obtained in addition to the operations and effects of the first embodiment.

(7) The function of the information generation unit that is stopped when the abnormality is detected is determined based on the moving direction of the vehicle 2 in the degenerate operation. As functions unnecessary for the degenerate traveling after the failure of the image recognition device 9, recognition processes of environmental elements related to areas of the right side and the right rear side of the vehicle 2 are targeted. This is due to a characteristic that recognition information of the areas of the right side and the right rear side is unnecessary because moving to the lane on the right side is not performed in the degenerate traveling for retreating to the nearby road shoulder.

### Modification Example 1 of Second Embodiment

Areas where the image recognition device 9 does not perform the recognition process when the degenerate operation is performed may be determined based on the speed of the vehicle 2 in the degenerate operation. For example, the slower the speed of the vehicle 2, the closer to the image recognition device 9 the area in which the recognition process is only required to be performed.

### Modification Example 2 of Second Embodiment

A radar, a laser radar, a sonar, or the like may be used as the sensors.

### Modification Example 3 of Second Embodiment

When performing the degenerate operation, the image recognition device 9 may decrease recognition accuracy based on the speed of the vehicle 2 in the degenerate operation. In general, the process of recognizing environmental elements by an external sensor involves large amounts of memory consumption and calculation, and thus by limiting a part of the calculation, it is highly possible that sufficient hardware resources can be secured for inserting the degenerate function. Thus, at a time of failure of the traveling control device 4, an external sensor-related device is preferable as a candidate for the reconfiguration destination of the functions necessary for the degenerate traveling.

### Third Embodiment

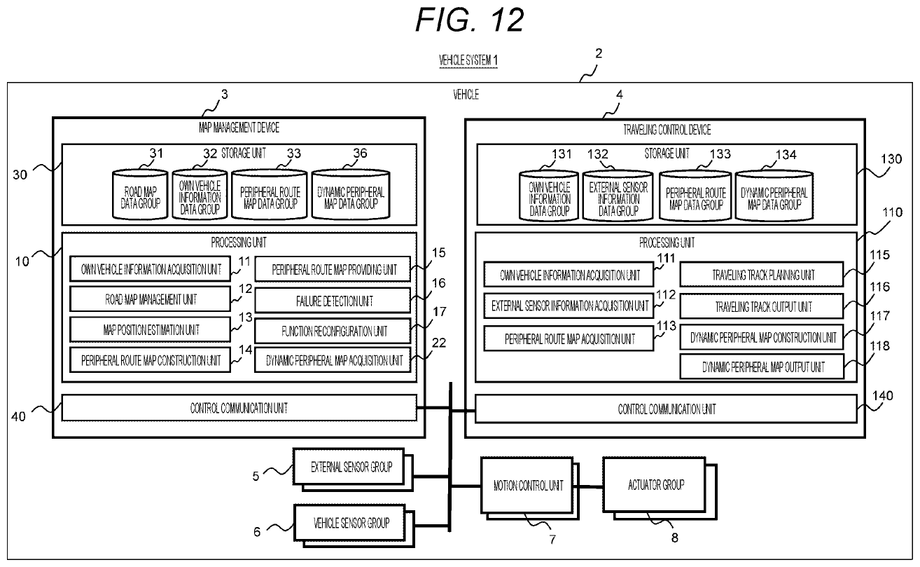

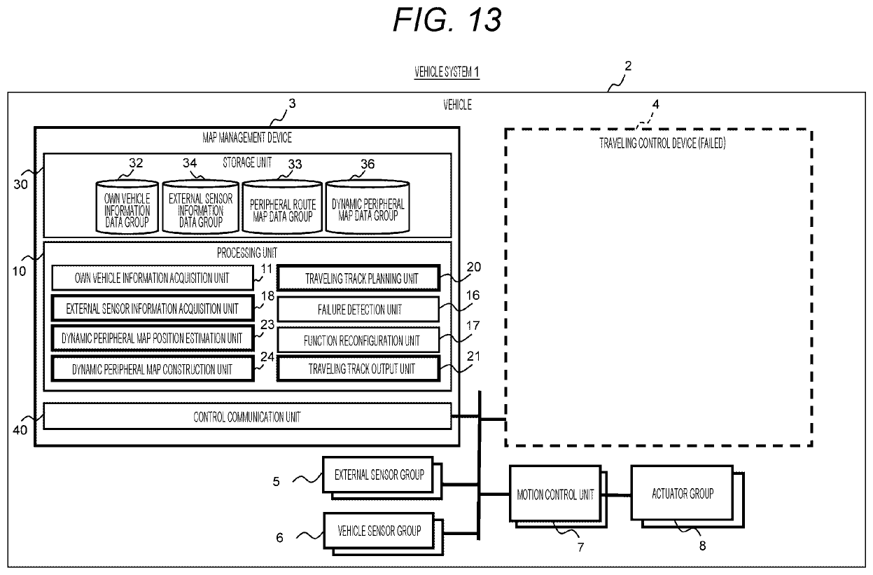

A third embodiment of a map management device, which is an electronic control unit, will be described with reference to FIGS. 12 and 13. In the following description, the same components as those in the first embodiment are designated by the same reference numerals, and differences will be mainly described. Points not particularly described are the same as those in the first embodiment.

(Outline of third embodiment) In the first embodiment, the peripheral route map data generated last time is retained in the storage unit 30 of the map management device 3 in which the degenerate traveling function is configured at a time of failure of the traveling control device 4. Thus, at the time of failure of the traveling control device 4, the map management device 3 combines the external sensor information data newly output from the external sensor group 5 and the peripheral route map data, and can immediately transit to the degenerate traveling after the reconfiguration. This is effective when the external sensor information data output from the external sensor group 5 is available as it is or becomes available in a short time.

However, because the data acquired by the sensors generally contains noise such as false detections and non-detections, it is often made available after improving accuracy by estimating a true value by combining a plurality of pieces of external sensor information data and time series data. In particular, when estimation is performed by combining the time-series data, it takes time to become available after the reconfiguration, and thus even if the degenerate traveling function is reconfigured, it is possible that it does not function effectively immediately.

In the third embodiment, in order to deal with such a case, not only the peripheral route map data which is static information but also dynamic peripheral map data is retained in the reconfiguration destination of the degenerate traveling function. The dynamic peripheral map data is a combination of a plurality of pieces of external sensor information data output from the external sensor group 5 and time series data thereof. Then, after the degenerate traveling function is reconfigured, a quick transition to the degenerate traveling is made by referring to the dynamic peripheral map data.

(Configuration at normal time) FIG. 12 is a functional block diagram illustrating a configuration of the vehicle system 1 according to the third embodiment. A device configuration in the vehicle system 1 according to the present embodiment is similar to that of the first embodiment except for the following points. That is, in the third embodiment, in the map management device 3, the processing unit 10 further includes a dynamic peripheral map acquisition unit 22, and the storage unit 30 further includes a dynamic peripheral map data group 36. Further, in the traveling control device 4, the processing unit 110 further includes a dynamic peripheral map construction unit 117 and a dynamic peripheral map output unit 118, and the storage unit 130 further includes a dynamic peripheral map data group 134.

The dynamic peripheral map acquisition unit 22 of the map management device 3 acquires dynamic peripheral map data generated by the traveling control device 4 and stores the data in the dynamic peripheral map data group 36 of the storage unit 30.

The dynamic peripheral map construction unit 117 of the traveling control device 4 constructs the dynamic peripheral map data by using the own vehicle information data group 131, the external sensor information data group 132, and the peripheral route map data group 133, and stores the data in the dynamic peripheral map data group 134. The dynamic peripheral map data is, for example, a special map that expresses the traveling environment around the vehicle 2 and is dynamically constructed by combining a plurality of pieces of external sensor information data and time series data thereof.

The dynamic peripheral map data corresponds to, for example, a grid map that divides a space around the vehicle 2 in a grid pattern and expresses states of the place. The state expressed in each lattice is, for example, presence or absence of an obstacle and a sensing state. From the dynamic peripheral map data, it is possible to grasp which area the vehicle 2 can travel. The dynamic peripheral map output unit 118 of the traveling control device 4 outputs the dynamic peripheral map data constructed by the dynamic peripheral map construction unit 117 to the in-vehicle network.

(Configuration at time of failure) FIG. 13 is a functional block diagram illustrating a configuration of the vehicle system 1 after the function reconfiguration due to occurrence of a failure of the traveling control device 4 in the third embodiment. In the present embodiment, the failure detection unit 16 of the map management device 3 detects a failure of the traveling control device 4. Then, the function reconfiguration unit 17 dynamically reconfigures a part of the processing unit and the storage unit of the map management device 3 to activate the degenerate traveling function which is an alternative function of the failed traveling control device 4. The degenerate traveling function here is an automatic traveling function for retreating to a nearby road shoulder on a dedicated road, as in the first embodiment.

The four functions of the road map management unit 12, the map position estimation unit 13, the peripheral route map construction unit 14, and the peripheral route map providing unit 15, which have been operating before the failure of the traveling control device 4, are functions for generating the peripheral route map data and providing the data to the traveling control device 4. However, for the purpose of retreating to the nearby road shoulder on the dedicated road, it is possible to correspond within the range of the peripheral route map data generated last time, and thus the four functions are not always necessary in the vehicle system 1 after occurrence of the failure of the traveling control device 4.

Therefore, the function reconfiguration unit 17 of the map management device 3 terminates these four non-essential functions. Then, instead of the above-mentioned four functions, the function reconfiguration unit 17 has, as functions for implementing the degenerate traveling function, the external sensor information acquisition unit 18, a dynamic peripheral map position estimation unit 23, the traveling track planning unit 20, and the traveling track output unit 21. At that time, the memory for storing the road map data group 31 of the storage unit 30 used by the road map management unit 12 is released, and the external sensor information data group 34 is stored instead.

The functions of the external sensor information acquisition unit 18, the traveling track planning unit 20, and the traveling track output unit 21 are equivalent to the external sensor information acquisition unit 18, the traveling track planning unit 20, and the traveling track output unit 21 illustrated in FIG. 2 of the first embodiment. The dynamic peripheral map position estimation unit 23 updates information of the position and attitude of the vehicle 2 based on the dynamic peripheral map data acquired last time from the traveling control device 4. Because the dynamic peripheral map data expresses a position of a stationary obstacle such as a roadside, by verifying a position of a stationary obstacle included in the external sensor information data newly acquired from the external sensor group 5, the dynamic peripheral map position estimation unit 23 updates the information of the position and attitude of the vehicle 2 in the dynamic peripheral map data.

The dynamic peripheral map construction unit 24 reflects the newly acquired external sensor information data in the dynamic peripheral map data based on the position and attitude of the vehicle 2 identified by the dynamic peripheral map position estimation unit 23. The processes of the dynamic peripheral map position estimation unit 23 and the dynamic peripheral map construction unit 24 can be implemented by applying a technique generally called simultaneous localization and mapping (SLAM).

According to the third embodiment described above, the following operations and effects can be obtained.

(8) The map management device 3 includes the storage unit 30 that stores the dynamic peripheral map data group 36 generated by the traveling control device 4 integrating the peripheral route map data group 33 and the recognition information acquired from the sensors. The traveling track planning unit 20 and the traveling track output unit 21 control automatic traveling based on the dynamic peripheral map data group 33. The map management device 3 constantly acquires and retains the dynamic peripheral map data generated by the traveling control device 4, and thus even if the traveling control device 4 fails and the degenerate traveling function is reconfigured, it is possible to quickly restore the traveling environment information around the vehicle 2 that has been recognized by the traveling control device 4.

(9) The traveling track planning unit 20 and the traveling track output unit 21 include the external sensor information acquisition unit 18 that acquires the recognition information from a part of the sensors. The traveling track planning unit 20 and the traveling track output unit 21 control the automatic traveling of the vehicle 2 based on the dynamic peripheral map data group 33 and the recognition information. Thus, even if it is necessary to plan the traveling track after recognizing the traveling environment around the vehicle 2 with high accuracy by combining a plurality of pieces of external sensor information data and time series data, it is possible to quickly transit to the degenerate traveling after the functions are reconfigured, and it becomes possible to make the transition and improve the safety of the vehicle system 1.

Note that the embodiments described above are examples, and the present invention is not limited to them. That is, various applications are possible, and all embodiments are included in the scope of the present invention. For example, in the above embodiments, the respective processes are described on the assumption to be executed by the same processing unit and storage unit in the map management device 3, but may be executed by a plurality of different processing units and storage units. In that case, for example, processing software having a similar configuration is installed in each storage unit, and each processing unit executes the processes in a shared manner.

Further, each process of the map management device 3 is achieved by executing a predetermined operating program using a processor and a RAM, but it can also be achieved by original hardware as necessary. Further, in the above embodiment, the map management device, the traveling control device, the external sensor group, the vehicle sensor group, the motion control unit, and the actuator group are described as individual devices, but any two or more of them can be achieved in combination as necessary.

Further, the drawings illustrate control lines and information lines that are considered necessary for describing the embodiments, and do not necessarily illustrate all control lines and information lines included in the actual product to which the present invention is applied. In practice, it may be considered that almost all components are interconnected.

The above-described embodiments and modification examples may be combined with each other. Although various embodiments and modification examples have been described above, the present invention is not limited to these contents. Other modes considered within the scope of the technical idea of the present invention are also included in the scope of the present invention.

The disclosure content of the next priority basic application is incorporated herein as a cited reference.

Japanese patent application 2018-141892 (filed on Jul. 27, 2018)

### REFERENCE SIGNS LIST

1 vehicle system
2 vehicle
3 map management device
4 traveling control device
5 external sensor group
6 vehicle sensor group
7 motion control unit
8 actuator group
9 image recognition device
10 processing unit
11 own vehicle information acquisition unit
12 road map management unit
13 map position estimation unit
14 peripheral route map construction unit
15 peripheral route map providing unit
16 failure detection unit
17 function reconfiguration unit
18 external sensor information acquisition unit
19 peripheral route map position estimation unit
20 traveling track planning unit
21 traveling track output unit
22 dynamic peripheral map acquisition unit
23 dynamic peripheral map position estimation unit
24 dynamic peripheral map construction unit
30 storage unit
31 road map data group
32 own vehicle information data group
33 peripheral route map data group
33 dynamic peripheral map data group
34 external sensor information data group
36 dynamic peripheral map data group
40 communication control unit

1. An electronic control unit comprising:
a control unit that controls automatic traveling of a vehicle;
an information generation unit that generates information necessary for the automatic traveling;
an abnormality detection unit that detects an abnormality; and
a function reconfiguration unit that lowers a functional level of the information generation unit and activates the control unit when the abnormality detection unit detects an abnormality.

2. The electronic control unit according to claim 1, wherein the function reconfiguration unit lowers the functional level of the information generation unit by stopping at least a part of the information generation unit.

3. The electronic control unit according to claim 1, wherein when the abnormality detection unit does not detect an abnormality, the control unit is in a stopped state.

4. The electronic control unit according to claim 2, wherein
the information necessary for the automatic traveling is peripheral route map data including road map data around the vehicle, and
the abnormality is an abnormality of a traveling control device that controls the automatic traveling of the vehicle based on the peripheral route map data.

5. The electronic control unit according to claim 1, further comprising a storage unit that stores the information necessary for the automatic traveling that is generated,
wherein the control unit controls the automatic traveling based on the information necessary for the automatic traveling that is generated last time.

6. The electronic control unit according to claim 4, further comprising a storage unit that stores dynamic peripheral map data generated by the traveling control device integrating the peripheral route map data and recognition information acquired from a sensor,
wherein the control unit controls the automatic traveling based on the dynamic peripheral map data.

7. The electronic control unit according to claim 6, wherein the control unit includes a sensor information acquisition unit that acquires the recognition information from a part of the sensor, and controls the automatic traveling of the vehicle based on the dynamic peripheral map data that is stored and the recognition information.

8. The electronic control unit according to claim 1, wherein the information necessary for the automatic traveling is static information of a road environment around the vehicle.

9. The electronic control unit according to claim 3, wherein a function of the information generation unit that is stopped when the abnormality is detected is determined based on at least one of a moving direction or a moving speed of the vehicle in a degenerate operation.
